(19) United States
(12) Patent Application Publication
(10) Pub. No.: US 2025/0062506 A1
(43) Pub. Date: Feb. 20, 2025

(54) TERMINAL PART FOR A SECONDARY CELL

(71) Applicant: NORTHVOLT AB, Stockholm (SE)

(72) Inventor: Dongho SON, Stockholm (SE)

(21) Appl. No.: 18/793,040

(22) Filed: Aug. 2, 2024

(30) Foreign Application Priority Data
Aug. 16, 2023 (SE) 2350968-0

(51) Int. Cl. H01M 50/559; B21D 53/20; H01M 50/179; H01M 50/188; H01M 50/531; H01M 50/567

(52) U.S. Cl. CPC H01M 50/559; B21D 53/20; H01M 50/179; H01M 50/188; H01M 50/531; H01M 50/567

(57) ABSTRACT

The present disclosure relates to a terminal part for a cylindrical secondary cell. The terminal part comprises a shaft configured to extend axially through a casing of the secondary cell, wherein a first end of the shaft is configured to provide an electrical connection with an electrode roll in the secondary cell; and a head arranged at a second end of the shaft, configured to form an external terminal for the cylindrical secondary cell. The shaft comprises a ridged shaft portion on a lateral surface of the shaft, wherein said ridged shaft portion comprises at least one ridge extending around the lateral surface of the shaft.

### BACKGROUND

### Related Field

The present disclosure relates to a terminal part for a secondary cell, a secondary cell comprising the terminal part, and a method of manufacturing such a secondary cell.

### Related Art

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### BRIEF SUMMARY

The present disclosure aims to provide improved secondary cells and parts thereof. The improvements may be in energy performance, manufacturing efficiency, decreased amount of material used, and assembly simplification, among others.

In particular, according to an aspect of the present disclosure, there is provided a terminal part for a cylindrical secondary cell. The terminal part comprising a shaft configured to extend axially through a casing of the secondary cell, wherein a first end of the shaft is configured to provide an electrical connection with an electrode roll in the secondary cell and a head arranged at a second end of the shaft, configured to form an external terminal for the cylindrical secondary cell. The shaft comprises a ridged shaft portion on a lateral surface of the shaft, wherein said ridged shaft portion comprises at least one ridge extending around the lateral surface of the shaft.

The overall shape of the cylindrical secondary cell may be substantially determined by its cylindrical casing, extending between two substantially flat ends. The first end of the cylindrical casing comprises an opening for receiving a terminal part, such as a terminal rivet. The opening may be shaped and sized to correspond to a shape and size of the shaft of the terminal part, allowing as well for the addition of a gasket around said shaft. The head of the terminal part may then extend like a flange from the second end of the shaft, such that the external portion is larger than the opening in the casing.

The head of a terminal rivet acts as an external terminal for the cell by being electrically conductive (e.g., formed from a metal such as aluminum or an alloy thereof) and electrically connected, via the first end of the shaft, to a current collecting disc. The current collecting disc (e.g., a cathode disc formed of aluminum or an alloy thereof) may then be arranged in direct electrical contact with the exposed tabs of the electrode roll of the cell (e.g., cathode tabs), at a first end of the electrode roll.

When shaft of the rivet is introduced into the opening of the casing, having a gasket therearound and a part of the gasket extending between the head and the casing of the cell, the opening in the casing may be sealed in a manner which strives to be substantially fluid-tight. The first end of the shaft may then be riveted and thereby deformed to retain the rivet in place in the opening of the casing, in a manner understood by those skilled in the art.

In some embodiments, terminal part is a terminal rivet. This means that the shaft of the rivet is intended to be deformed in a riveting process, to expand radially around the axis so that rivet can be retained in the opening of the casing.

In the present disclosure, the shaft of the terminal part, which may be a rivet, is provided with a ridged shaft portion comprising at least one ridge extending around the lateral surface of the shaft. Upon assembly of the cylindrical cell, the ridged portion will at abut and preferably at least elastically deform the gasket by extending into the material of the gasket, such that a tighter seal between the gasket and the terminal part may be obtained. This is advantageous in that reduces the risk of electrolyte leaking from the canister. Electrolyte fluid is typically corrosive and harmful. The provision of a tighter seal therefore improves the operational reliability of the cell.

The term “ridged shaft portion” is intended to denote a part of the shaft which is provided with at least one ridge which extends around an lateral surface of the shaft. The term “ridge” refers to a narrow (typically less than 5 mm wide, such as less than 4 mm wide, such as less than 3 mm wide, such as less than 2 mm wide, such as less than 1 mm wide) protrusion which extends around at least part of a lap around the outer lateral surface of the shaft. The ridge may have a height of at least 1 mm, such as of at least 2 mm, such as of at least 3 mm, such as of at least 3 mm, such as of at least 4 mm, such as of at least 5 mm, measured from a part of the shaft which does not contain any ridges. The ridge is preferably made as an integral part of the shaft and may be manufactured by machining (e.g. on a lathe, by laser cutting) or by other means known to the person skilled in the art.

Lateral surface refers to any outer surface of the shaft, excluding the first end and the second end.

Preferably, the ridge is continuous for at least one lap around the lateral surface of the shaft. Alternatively, it may extend about only a part of a lap around the lateral surface of the shaft. The ridge may also extend about at leas one lap of the shaft, but in a discontinuous manner, meaning that the ridge is comprised of several ridge portions, where adjacent ridge portions are separated by portions of the shaft which does not contain a ridge. The ridge may be provided to extend substantially perpendicular to the axis A of the shaft, such that (if the ridge extends for a full lap around the lateral surface) the ridge starts and ends in the same point on the shaft. It may, alternatively, be provided at an angle in relation to a length axis of the shaft.

In some embodiments, the ridged shaft portion is a threaded portion in which the at least one ridge extends helically around the lateral outer surface of the shaft. The threaded portion can then act as a screw thread, meaning that the terminal part can be screwed into the opening by the interaction between the threaded portion and the gasket, upon the provision of a rotational force acting upon the head of the terminal part which forces it to rotate about its own axis.

Such a configuration thus alleviates the insertion of the terminal part into the opening of the casing. It can further act a fastener which keeps the terminal part in place in the opening of the casing. During insertion, the screw will elastically deform the gasket and thereby create a substantially fluid tight seal retaining the terminal part in place in the cylindrical cell.

A thread or screw thread is known to the person skilled in the art, but is intended to denote a ridge which extends helically round the shaft, which in this embodiment preferably is cylindrical. The ridge preferably extends helically more than one lap around the lateral outer surface of the shaft, such as at least 2 laps, or at least 3 laps, or at least 5 laps, or at least 10 laps or more.

Once the terminal part has been screwed in place in the secondary cylindrical cell, it may be riveted to provide additional attachment to the casing.

The threaded portion may be provided with at least two starts, meaning that there is in fact at least two ridges which extends helically around the lateral outer surface in the threaded shaft portion.

In alternative embodiments, the ridged shaft portion comprises a plurality of ridges, each extending around the lateral outer surface of the shaft. In this embodiment the ridges are not provided in helically around the shaft. Instead, a plurality of ridges is provided, each ridge extending around the shaft in a plane which is substantially perpendicular to a length axis of the shaft. The ridges are thus provided in parallel but lengthwise separated planes along the lateral surface of the shaft. This embodiment advantageously provides a substantially fluid tight seal in the casing since the ridges holds the terminal part in place by elastically deforming the gasket.

In embodiments, the ridged shaft portion comprises at least three ridges, such as at least 4 ridges, such as at least 5 ridges, such as least 6 ridges, such as at least 10 ridges.

In embodiments, the shaft is cylindrical and configured to extend axially through a circular opening in the casing of the cylindrical secondary cell. Consequently, the gasket may advantageously be provided in the shape of an o-ring.

In a pre-riveted state, least part of the cylindrical shaft may be hollow. During riveting, the walls of the cylinder may then deform to expand radially about a length axis of the shaft.

Alternatively, the cylindrical shaft may be solid, in which case the shaft will also deform to radially expand around the length axis during riveting.

In embodiments, the ridged shaft portion extends along at least ⅓ of the length of the shaft. This a been proven as good compromise between providing sufficient friction with the gasket, and to not interfere with the parts of the shaft being configured to be deformed during a riveting process.

In embodiments, the head is substantially disc shaped and configured to close the circular opening in the casing of the cylindrical secondary cell. Thus, the head is provided a disc shaped flange on the shaft.

In some embodiments, the head comprises a ridged head portion arranged at surface of the head adapted to face the casing, wherein the ridged head portion comprises at least one ridge extending around the shaft.

In order to further increase the reliability of the substantially fluid-tight seal between the terminal part and the gasket, an underside of the head of the terminal part may be provided with ridged extending radially around the shaft. The ridged portion on the head is intended to abut the gasket in a similar manner as the ridged portion on the shaft, and to function in a corresponding manner to further increase the reliability of the seal.

In embodiments, the ridged head portion at least comprises at least three ridges extending around the shaft. Much like for the ridged portion on the shaft, the ridged portion on the head may be formed by a plurality of rings extending concentrically (circular or otherwise) around the shaft. Each ridge is preferably continuous for a full lap about the shaft, but it may also be discontinuous.

In embodiments, the ridged head portion is a threaded portion in which the at least one ridge extends helically around the shaft. This configuration additionally alleviates the insertion of the terminal part in the casing, as it allows for a screwing motion to be utilized. The configuration of the threaded head portion is typically selected such that it corresponds to a configuration of the threaded shaft portion. Preferably, the ridge extends helically at least two laps around the shaft. The ridged head portion may preferably extend along ⅕ of a radius of the disc shaped head.

In another aspect of the present disclosure, there is provided A cylindrical secondary cell comprising an electrode roll housed in a cylindrical casing, a terminal part according to any preceding claim, arranged at a first end of the cylindrical casing, a gasket extending between the head of the terminal part and the casing, wherein the terminal part) is arranged such that the ridged shaft portion abuts the gasket. Additional features of the cylindrical secondary cell are described in relation to the previous aspect discussed in this disclosure.

In some embodiments, the secondary cell further comprises a current collecting plate (536) in direct electrical contact with the electrode roll, wherein the first end of the shaft of the terminal rivet is in direct electrical contact with the current collecting plate.

Alternatively, the terminal part may be configured to be in direct electrical contact with the electrode roll.

In another aspect of the present disclosure, there is provided a method for manufacturing a secondary cell as defined above. The method comprises arranging the terminal part and the gasket in the cylindrical casing at a first end of the thereof, and such that the ridged shaft portion abuts the gasket.

If the terminal part comprises a threaded shaft portion, the terminal part may be arranged in the casing by application of a screwing motion, such that the terminal part may be screwed into the gasket. This would advantageously facilitate the insertion of the terminal part into the casing to abut the gasket.

After the terminal part has been arranged in the casing, the shaft of the terminal part may then be riveted to thereby secure the terminal rivet in place at the first end of the casing. The riveting is performed by application of a force to the shaft such that part of the shaft is deformed to radially extend about a lengthwise axis of the shaft. The force should be sufficient to plastically deform part of the shaft. Riveting may be performed be a plethora of means known to the person skilled in the art.

In embodiments, the method further comprises arranging a current collecting plate such that the current collecting plate is in direct electrical contact with a connecting portion on the electrode roll, and such that the first end of the shaft of the terminal part is in direct electrical contact with the current collecting plate.

The electrode roll may comprise respective pluralities of notched tabs extending from its ends, wherein a first plurality of notched tabs are extensions of or attachments to the cathode electrode sheet, and a second plurality of notched tabs at the opposite end are extensions of or attachments to the anode electrode sheet. The tabs may be folded over to form a connective surface for welding or otherwise attaching a current collecting plate to.

The current collecting plate is preferably welded to the electrode tabs before the current collecting plate and electrode roll is inserted into the casing.

The welding may be performed by welding means which may be a welding laser, soldering iron, ultrasonic welding, capacitor discharge welding, or any other suitable welding means whose welding energy may be effectively communicated through the material path formed between the relatively thin current collecting plate.

The current collecting plate is typically welded to the current collecting plate after the terminal part has been riveted. The welding is typically performed by directing a welding means to the upper facing surface of the head of the terminal part.

Accordingly, aspects of the present disclosure provide improvements in energy performance, manufacturing efficiency, and assembly simplification, for terminal rivets and the cylindrical secondary cells in which they are installed, among other advantages which will be made clear through the below description of specific embodiments.

### BRIEF DESCRIPTION OF THE FIGURES

One or more embodiments of the present disclosure will be described, by way of example only, and with reference to the following figures, in which:

FIG. 1 schematically shows a side cross-sectional view of a terminal part according to aspects of the present disclosure;

FIGS. 2A and 2B schematically show side cross-sectional views of a terminal part before riveting and after riveting, according to aspects of the present disclosure, respectively;

FIGS. 3A and 3B schematically show side cross-sectional views of a terminal part before riveting and after riveting, according to aspects of the present disclosure, respectively;

FIGS. 4A and 4B schematically show a zoomed-in cross-sectional view of a terminal part placed in relation to a gasket, according to aspects of the present disclosure;

FIG. 5 schematically shows a cross-sectional view of a cylindrical secondary cell according to aspects of the present disclosure; and

FIG. 6 illustrates a method of manufacturing a cylindrical secondary cell, according to aspects of the present disclosure.

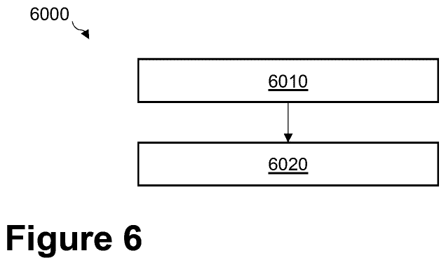

### DETAILED DESCRIPTION

The present disclosure is described in the following by way of a number of illustrative examples. It will be appreciated that these examples are provided for illustration and explanation only and are not intended to be limiting on the scope of the present disclosure. Instead, the scope of the present disclosure is defined by the appended claims.

Furthermore, although embodiments be presented individually for the sake of focused discussion of particular features, it will be recognized that the present disclosure also encompasses combinations of the embodiments described herein.

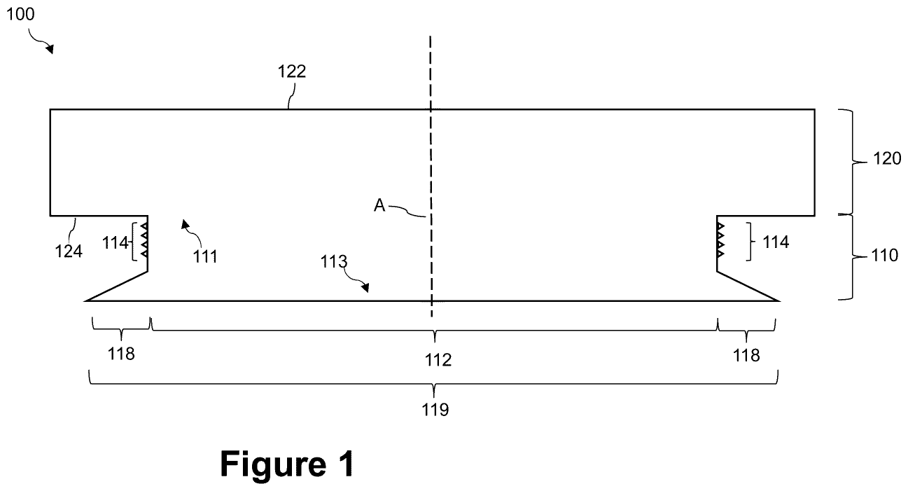

FIG. 1 show a side cross-sectional view of a terminal part according to aspects of the present disclosure.

As shown in FIG. 1, the terminal part 100 comprises a shaft 110 and a head 120 arranged at an end 111 of the shaft 110. The head 120, and in particular the surface 122, is configured to form an external terminal for a cylindrical secondary cell. The shaft 110 is configured to extend through a casing of the secondary cell, such that it can provide an electrical connection with an electrode roll in a secondary cell at the other end of the shaft 113.

This electrical connection is typically formed by that there is provided a surface 119 at the end 113 of the shaft, which surface 119 of the shaft 110 is in direct electrical connection with a current collecting plate, which in turn is in direct electrical contact with the electrode roll in the secondary cell. The surface 119 is preferably welded to the current collecting plate by mean known to a person skilled in the art.

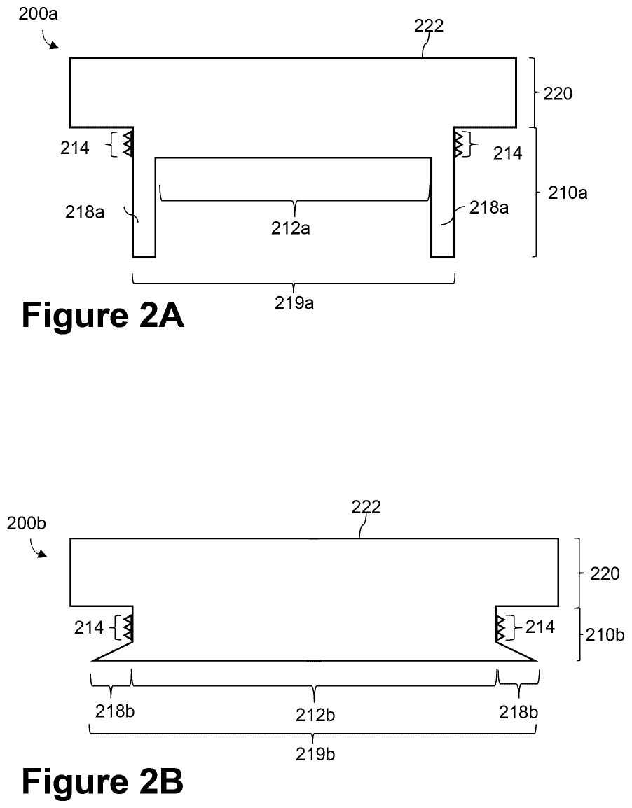

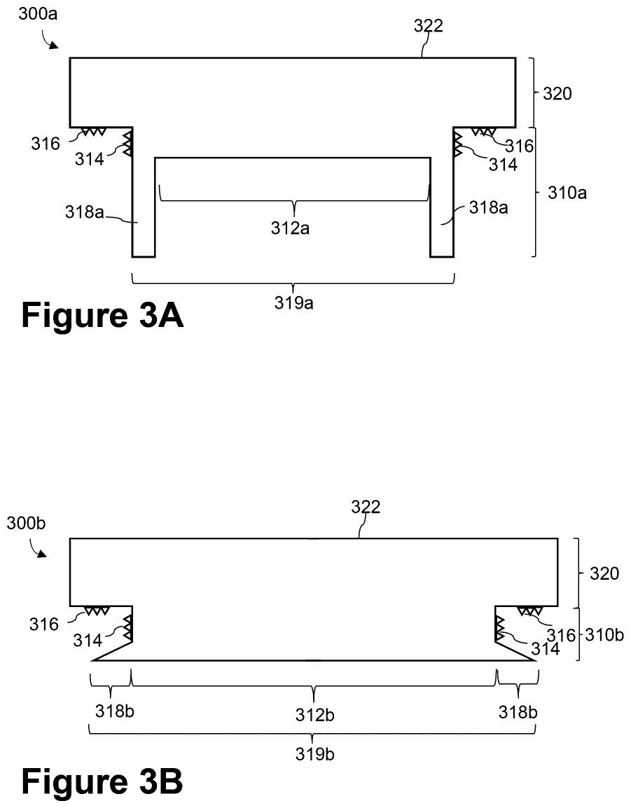

The surface 119 at the first end 113 of the shaft 110 comprises a first region 112 and a second region 118 which has been formed as a result of the riveting of the rivet 100, which is discussed in more detail in connection with FIGS. 2A-B and FIGS. 3A-B.

In this illustrated example, the shaft 110 is formed substantially as a cylinder and the head 120 is formed as a disc (i.e., as a cylinder having a greater radius than the shaft 110) and the substantially circular profiles of the shaft 110 and head 120 are concentric around the axis A.

On the shaft 110, there is provided a ridged shaft portion 144. The ridged shaft portion is comprised of at least one ridge which extends around the lateral surface of the shaft 110. When the terminal part 100 is arranged in a secondary cell, the ridged shaft portion 114 is configured to abut a gasket positioned between the terminal part 100 and the casing such that the ridge or ridges of the ridged shaft portion 114 interacts with the gasket to provide additional friction which helps in keeping the terminal part 110 retained in the casing and also to, with surface 124 of the head 120, provide a tight seal which prevents leakage of electrolyte from the cell.

The ridged shaft portion 114 may be formed of at least one ridge which extends helically around the shaft, thereby forming a threaded surface portion 114. In such embodiments, the threads advantageously allow for the terminal part 100 to be screwed in place in the casing, as a rotational motion of the terminal part 110 would cause the threaded shaft portion 114 to interact with the gasket and drive the terminal part 100 down into the casing.

In some embodiments, this attachment is considered sufficient, and the terminal part need not be a rivet. In other embodiments, the terminal part is a rivet which is riveted in place after being inserted in the casing by screwing.

In other embodiments, the ridged shaft portion 114 comprises a plurality of ridges each extending concentrically around the shaft 114.

FIG. 2A-B schematically show a rivet 200a before riveting and a rivet 200b after riveting

The rivet 200a may formed by, for example, cold pressing, additive or subtractive manufacturing, or other techniques, depending on the material from which the rivet 200a is formed (such as aluminum or an alloy thereof). In its pre-riveted state, the rivet 200a comprises a portion 218a intended to be deformed during a rivet process and thereby expanded radially outwards—as shown in FIG. 2B—so as to cause the rivet 200b to be held in place in the casing of the cell. After riveting, the surfaces 212b and 218b together form the surface 219b, which is intended to contact the current collecting plate in the secondary cell.

The particulars of the riveting process are not discussed at length but a number of techniques for riveting rivets 200a, such as those described herein, are well understood by those skilled in the art.

As can be seen if FIGS. 2A and 2B, several parts of the rivet 200b have not been affected (or at least not deformed) by the riveting process. The head 220 and its surfaces 222 and 224 remain substantially undeformed after riveting. The shaft 210b, on the other hand, is partially deformed as described above. However the ridged shaft portion 214. Remains substantially undeformed after riveting. This is advantageous as it allows for a design of the external terminal that is not altered during the riveting process. Further, it allows for correct dimensioning of the surface 224 and the ridged shaft portion which together are configured to form a seal with the gasket.

FIGS. 3A-3B shows a nearly identical example as shown in FIGS. 2A-2B, with the difference that the surface 324 of the head of the rivet is provided with a ridged head portion 316, which is also not deformed during the riveting. The remaining he particulars of the rivet 300a, b are thus not discussed again in relation to FIGS. 3A-3B.

The ridged head portion 116 comprises at least one ridge which extends on the surface 324 of the head 320 around the shaft 310. The ridged head portion is configured to interact with a gasket in the secondary cell to further increase the reliability of the seal formed between the terminal part 300 and the gasket.

The ridged head portion 314 may be formed of a ridge which extends helically around the shaft, thereby forming a threaded head portion 314. Alternatively, it may comprise a plurality of concentric ridges each extending around the shaft.

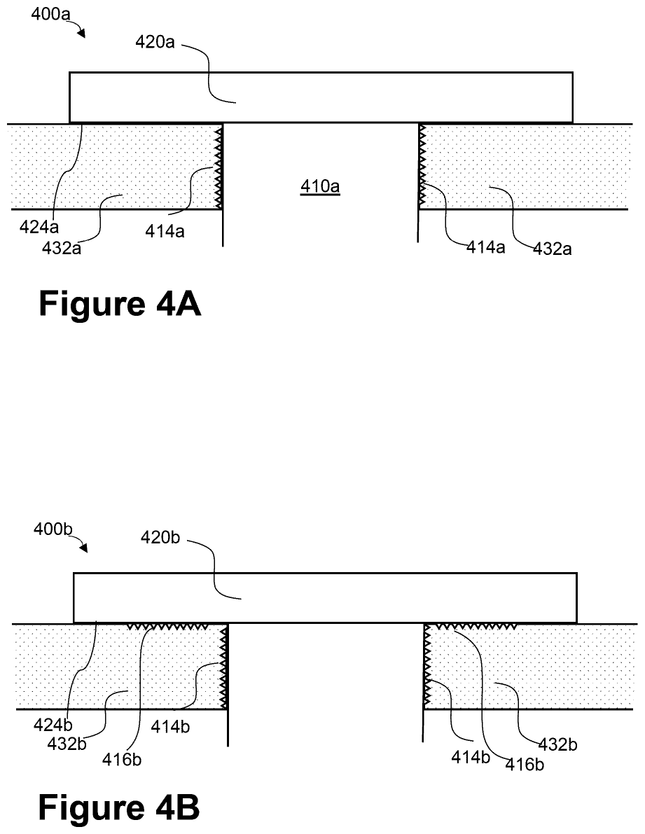

FIGS. 4A and 4B schematically illustrate detailed cross-sectional side views of terminal rivets 400a and 400b and their interaction with gaskets 432a and 432b.

The gaskets 432a and 432b are illustrated herein as O-rings each having a hole in which the shafts 410a, 410b of the rivets 400a, 400b can extend through in a substantially snugly fitting manner. A can be seen, the heads 420a, 420b are provided with their lower surfaces 424a, 424b resting against and abutting the gaskets 432a, 432b. The shafts 410a, 410b are each provided with a ridged shaft portion 414a, 414b, which interacts with the gaskets 432a, 432b. The ridged shaft portions 414a, 414b are provided such that the at least one ridge provided therein elastically deforms the gasket during insertion of the terminal parts 400a, 400b into the gaskets 432a, 432b. This provides a force from the gasket which acts on the ridged shaft portion 414a, 414b which helps retain the terminal part in the casing of the secondary cell, and to provide a tight seal which prevents electrolyte from leaking from the cell.

FIG. 4B additionally shows that the rivet 400b is provided with a ridged head portion 416b on the downwards facing surface 424b of the head. The ridged head portion 416b serves a similar purpose as the ridged shaft portions 414a, 414b in that it helps retain the terminal part 400b in the casing of the secondary cell via its interaction with the gasket 432b, and in that it additionally helps provide a fluid-tight seal between terminal part 400b and the gasket 432b

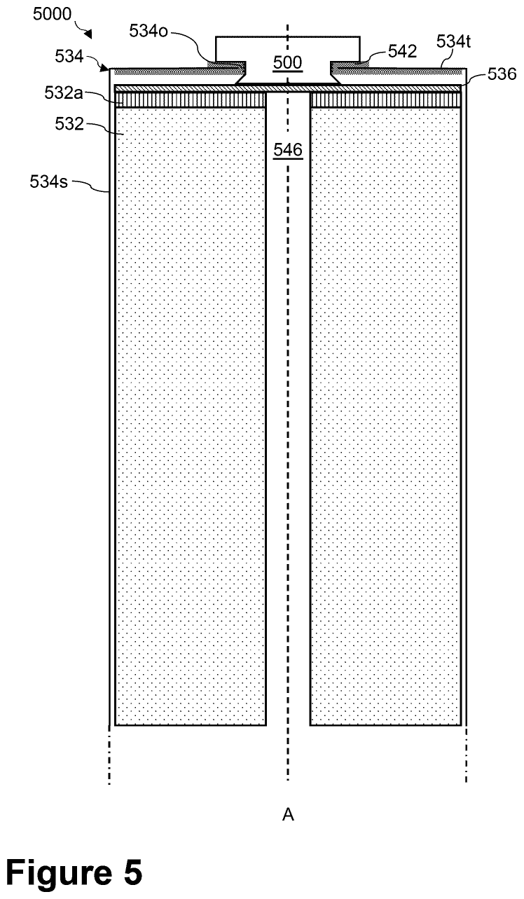

FIG. 5 schematically shows a cross-sectional view of a cylindrical secondary cell 5000 comprising a rivet 500 extending through an opening 5340 in the casing 534, corresponding to the example rivet 100 shown and discussed in relation to FIG. 1. The particulars of the rivet 100 are thus not discussed again in relation to FIG. 5.

The cylindrical secondary cell 5000 (also referred to as simply the ‘cell 5000’) comprises an electrode roll 532 housed in a cylindrical casing 534. The electrode roll 532 may be formed of an anode sheet, a cathode sheet, and a separator sheet arranged therebetween to thereby enable a storage of electrical energy. Cathode tabs 532a may extend from a first end of the electrode roll 532 and anode tabs (not shown) may extend from the other end, or vice versa. The cathode tabs 532a and anode tabs may provide connective surfaces to which current collecting plates 536 can be connected.

The cylindrical casing 534 extends along an axis A between a first end 534t, which may be referred to as a ‘top end 534t’, and a bottom end (not shown) which may be an open end of the casing 534 closed by a lid. The closure of the casing may comprise a clamped closure or a welded closure, depending on the implementation.

For example, the casing 534 may further comprise a beading groove (not shown) formed in the side wall 534s. Hence, between the beading groove and the end edge of the side wall towards the bottom end of the casing, a clamping portion can be formed. A lid gasket may then be clamped around the bottom lid in the clamping portion to thereby seal the open bottom end of the casing. Providing a clamped closure in this way is well known in the art and thus can provide a reliable waterproof seal for the cell.

As another example, the lid may be welded to the casing to thereby seal the casing. The lid may be additionally welded to a current collector, or the lid may act as a current collector itself and be attached (e.g., welded) to the tabs of the electrode assembly 532. Providing a welded closure in this way may advantageously remove the number of components of the cell and/or the number of process steps required to manufacture the cell.

A cathode current collecting plate 536 is arranged in direct electrical contact with the cathode tabs 532a and an anode current collecting plate (not shown) may be arranged in direct electrical contact with the anode tabs (also not shown). Here, the labels ‘cathode’ and ‘anode’ may be swapped. Thus, an electrical connection is formed from the cathode tabs 532a to the terminal assembly, as the terminal assembly is connected to the current collecting plate 536.

An electrical connection may also formed from the anode tabs to the casing 534, either directly or through connection of an anode current collecting plate to the casing 534, e.g. in the clamping portion or by welding. One or both or the current collectors may be formed as a disc, a plate, or have some other shape.

At either end of the cell, the cell may further comprise a vent for venting gases, for example during a failure of the cell. Moreover, the cell may comprise an additional through-hole, in the casing and/or the lid, for filling the cell with a liquid electrolyte. This through-hole is preferably adapted to be closed from the outside, such as through the use of a blind rivet.

Thus, it is seen that the exposed head of the terminal rivet 500 serves as an external terminal of the cell 5000, this being a positive terminal in this example, and the casing 534 serves as the negative terminal. Hence, it is seen that both terminals of the cell 5000 are accessible at the same side. The top end 534t of the casing 534 comprises a first electrical contact surface extending in a first plane, and the head of the rivet 500 comprises a second electrical contact surface, extending in a second plane axially spaced from the first plane.

Arranged around the terminal rivet 500 is a gasket 542 configured to form a fluid-tight seal for the opening 5340 in the top end 534t of the casing 534. The gasket 542 is arranged at least around the shaft of the rivet 500. The gasket 542 further extends between the head of the rivet 600 and the top end 534t of the casing 534 so as to electrically isolate the opposite terminals of the cell 5000 from each other. Thus, it can be seen that gasket 542 serves multiple purposes. The gasket 542 may be preferably formed of a polymer having elastic, resilient, and electrically insulating properties, such as PFA. In preferred examples, including that illustrated in FIG. 5, the gasket 542 extends between the head of the rivet 500 and the casing 534, radially beyond the head of the rivet 500.

In some examples, the gasket 542 may be formed of separate parts, each part being specifically configured for a respective purpose. For example, for the part(s) of the gasket 542 around the opening 5340 and intended to seal the opening, the gasket 542 may be formed of one material such as PFA. For the part(s) of the gasket 542 between the head of the rivet 600 and the casing 634 and intended to electrically isolate these components from each other, the gasket 542 may be formed from another material such as a PPS polymer.

Preferably, the material of the gasket 542 should be selected such that the ridged shaft portion can deform the gasket during insertion of the terminal part, without inducing cracks in the gasket 542.

The electrode roll 532 is arranged around a center pin 546, although in other examples, this may be an empty space or cavity

FIG. 7 illustrates a method of manufacturing (a part of) a cylindrical secondary cell, according to aspects of the present disclosure. The method comprises arranging (6010) the terminal part and the gasket in the cylindrical casing at a first end of the thereof, and such that the ridged shaft portion abuts the gasket, and optionally also arranging (6020) a current collecting plate such that the current collecting plate is in direct electrical contact with a connecting portion on the electrode roll, and such that the first end of the shaft of the terminal part is in direct electrical contact with the current collecting plate.

In embodiments where the ridged shaft portion is a threaded shaft portion, the step of arranging the terminal part and the gasket involves screwing the terminal part in place in the gasket.

The optional step of arranging a current collecting plate with a connecting portion on the electrode roll typically involves welding the current collecting plate to the electrode tabs on the electrode roll. The remaining steps for manufacturing the cell are not discussed in detail herein, but are well understood by those skilled in the art.

While the present disclosure is susceptible to various modifications and alternative forms, specific embodiments are shown and described above by way of example in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims.

1-19. (canceled)

20. A terminal rivet (100) for a cylindrical secondary cell comprising:
a shaft (110) configured to extend axially through a casing of the secondary cell, wherein a first end of the shaft is configured to provide an electrical connection with an electrode roll in the secondary cell; and
a head (120) arranged at a second end of the shaft, configured to form an external terminal for the cylindrical secondary cell,
wherein:
the shaft (110) comprises a threaded shaft portion (114) on a lateral surface of the shaft (110), and
said threaded shaft portion (114) comprises at least one ridge extending helically around the lateral surface (110b) of the shaft (110).

21. The terminal rivet (100) according to claim 20, wherein the at least one ridge extends helically at least two laps around the lateral outer surface of the shaft.

22. The terminal rivet (100) according to claim 21, wherein the shaft (110) is cylindrical and configured to extend axially through a circular opening in the casing of the cylindrical secondary cell.

23. The terminal rivet (100) according to claim 20, wherein the shaft (110) is cylindrical and configured to extend axially through a circular opening in the casing of the cylindrical secondary cell.

24. The terminal rivet (100) according to claim 23, wherein the at least part of the cylindrical shaft (110) is hollow.

25. The terminal rivet (100) according to claim 20, wherein the threaded shaft portion (114) extends along at least ⅓ of the length of the shaft (110).

26. The terminal rivet (100) according to claim 20, wherein the head (120) is substantially disc shaped, configured to close the circular opening in the casing of the cylindrical secondary cell.

27. The terminal rivet (100) according to claim 26, wherein:
the head (120) comprises a ridged head portion (116) arranged at surface of the head adapted to face the casing (124), and
the ridged head portion (116) comprises at least one ridge extending around the shaft (110).

28. The terminal rivet (100) according to claim 27, wherein the ridged head portion (116) at least comprises at least three ridges extending around the shaft (110).

29. The terminal rivet (100) according to claim 27, wherein ridged head portion (116) is a threaded portion (116) in which the at least one ridge extends helically around the shaft (110).

30. The terminal rivet (100) according to claim 29, wherein the ridge extends at least two laps around the shaft (110).

31. The terminal rivet (100) according to claim 27, wherein the ridged head portion (116) extends along ⅕ of a radius of the disc shaped head (120).

32. A cylindrical secondary cell (5000), comprising:
an electrode roll (532) housed in a cylindrical casing (534);
a terminal rivet (500) according to claim 20, arranged at a first end of the cylindrical casing; and
a gasket (542) extending between the head of the terminal part and the casing,
wherein the terminal part (500) is arranged such that the ridged shaft portion abuts the gasket (542).

33. The cylindrical secondary cell according to claim 32, further comprising
a current collecting plate (536) in direct electrical contact with the electrode roll (532),
wherein the first end of the shaft of the terminal rivet (500) is in direct electrical contact with the current collecting plate.

34. A method for manufacturing the cylindrical secondary cell according to claim 33, further comprising arranging (6010) the terminal rivet and the gasket in the cylindrical casing at a first end of the thereof, and such that the threaded shaft portion abuts the gasket.

35. The method according to claim 34, further comprising arranging (6020) a current collecting plate such that the current collecting plate is in direct electrical contact with a connecting portion on the electrode roll, and such that the first end of the shaft of the terminal rivet is in direct electrical contact with the current collecting plate.

36. A method for manufacturing the cylindrical secondary cell according to claim 32, further comprising arranging (6010) the terminal rivet and the gasket in the cylindrical casing at a first end of the thereof, and such that the threaded shaft portion abuts the gasket.
